(19) United States
(12) Patent Application Publication
(10) Pub. No.: US 2017/0187155 A1
(43) Pub. Date: Jun. 29, 2017

(54) WIRING DEVICE WITH CONNECTOR INTEGRATED INTO PCB SUBSTRATE

(71) Applicant: Leviton Manufacturing Co., Inc., Melville, NY (US)

(72) Inventors: Ronald Jansen, Ridgewood, NY (US); Adam Kevelos, Plainview, NY (US); Michael Kamor, North Massapequa, NY (US)

(73) Assignee: Leviton Manufacturing Co., Inc., Melville, NY (US)

(21) Appl. No.: 14/982,278

(22) Filed: Dec. 29, 2015

(51) Int. Cl. H01R 27/02; H01R 12/70; H01R 24/60

(52) U.S. Cl. CPC H01R 27/02; H01R 24/60; H01R 12/7088

(57) ABSTRACT

A wiring device includes a housing that encloses a line voltage port and a low-voltage port for providing power to at least one removable load. The removable load can couple to a connector PCB. The connector PCB may include a tongue portion with retention surface features and a body portion with supporting circuitry. The tongue portion may be disposed within a low-voltage port of the wiring device. A plurality of conductive traces may extend from the body to the tongue of the connector PCB. The low voltage port may include sidewalls disposed around the tongue portion to guide the plug of a removable load into engagement with the conductive traces of the tongue portion so that one or more of the plurality of conductive traces electrically contact the removable load to deliver power to the removable load.

### FIELD OF THE DISCLOSURE

The present disclosure relates generally to wiring devices having low-voltage ports, and more particularly to a low-voltage port incorporating a connector tongue formed from a printed circuit board (PCB) with support circuitry.

### BACKGROUND OF THE DISCLOSURE

Residential buildings have wall outlets for powering electronic devices such as lights, appliances, computers, and mobile devices. A wall outlet is sometimes referred to as an alternating current (AC) wall charger because most conventional wall outlets charge AC powered devices. The AC powered devices have a power cord with a plug configured to be connected to and removed from the wall outlet.

Due to the proliferation of various consumer electronic device that are powered by batteries providing direct current (DC), such as cell phones, laptops, tablets, personal digital assistants (PDA's), and the like, there is a need to power and/or charge such devices. Many of these devices may be facilitated through the use of standard interfaces such as a Universal Serial Bus (USB) charging device. Some of these charging devices have been incorporated into wall outlets. Such charging devices may be designed to provide power to multiple electronic devices simultaneously through low-voltage ports.

Where the standard interface is a USB interface, for example, the wall outlet is typically fitted with one or more preformed USB receptacles which are coupled to the internal charging circuitry housed within the outlet. The disadvantage of using preformed receptacles is that the internal electrical and mechanical layout of the wall outlet must conform to the receptacle dimensions. In addition, preformed receptacles typically include separate guide/housing structures that also need to be accommodated within the wall outlet. As will be appreciated, these dimensions often differ between suppliers, and as a result the fit, form and function of the resulting outlet can be affected depending on which supplier's receptacle is chosen.

### SUMMARY

This summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A wiring device is disclosed. The wiring device may include a housing having a low-voltage port, and a connector printed circuit board (PCB) disposed within the housing. The connector PCB may have a tongue portion, a body portion and a conductive trace. The conductive trace may be disposed on the tongue portion and the body portion. A first end of the tongue portion may be disposed within the low-voltage port. The low-voltage port may comprise a plurality of sidewalls configured to receive the plug of a removable load to guide the plug into engagement with the tongue portion so that the contacts on the plug align and conductively engage with the conductive traces of the tongue portion.

A wiring device is disclosed. The wiring device may include a housing including a low voltage port and a connector printed circuit board (PCB) including a body portion and a tongue portion. The connector PCB may include a first conductive trace with first and second ends, the first end located on the body portion and the second end located on the tongue portion. The connector PCB may include a second conductive trace with first and second ends, the first end located on the body portion and the second end located on the tongue portion. The tongue portion may have a first end disposed within the low voltage port. The low-voltage port may include a sidewall disposed adjacent the tongue portion, the sidewall configured to receive a surface of the plug of a removable load to guide the plug into engagement with the tongue portion so that first and second electrical contacts on the plug align and conductively engage with the conductive traces of the tongue portion.

A wiring device is disclosed. The wiring device may include a housing including a low voltage port, and a connector printed circuit board (PCB) including a body portion and a tongue portion. The tongue portion may have a first end disposed within the low voltage port and a plurality of conductive traces each having first and second ends, the first ends disposed on the body portion and the second ends disposed on the tongue portion. The a front portion of the housing may have a plurality of sidewalls disposed around the tongue portion, the plurality of sidewalls comprising a guide channel for receiving and guiding a plug of a removable load into engagement with the tongue portion so that a contact on the plug conductively engages with at least one of the conductive traces of the tongue portion.

### BRIEF DESCRIPTION OF THE DRAWINGS

By way of example, exemplary embodiments of the disclosed device will now be described, with reference to the accompanying drawings, in which:

FIG. 1 is an isometric view of an exemplary embodiment of a wiring device according to the present disclosure;

FIG. 2 is a cross-section view of the wiring device of FIG. 1 taken along line 2-2 of FIG. 1;

FIG. 3 is a cutaway view of the wiring device of FIG. 1;

FIG. 4 is a block diagram of an exemplary embodiment of a connector PCB according to the present disclosure; and

FIG. 5 is a block diagram of an exemplary embodiment of a wiring device according to the present disclosure.

### DETAILED DESCRIPTION

The following disclosure is intended to provide exemplary embodiments of the disclosed system and method, and these exemplary embodiments should not be interpreted as limiting. One of ordinary skill in the art will understand that the steps and methods disclosed may easily be reordered and manipulated into many configurations, provided they are not mutually exclusive. As used herein, “a” and “an” may refer to a single or plurality of items and should not be interpreted as exclusively singular unless explicitly stated.

A wiring device is disclosed in which a tongue portion of a low-voltage connector, which in one non-limiting exemplary embodiment is a Universal Serial Bus (USB) C connector, is integrated into a printed circuit board (PCB) of the wiring device. The tongue portion can be housed within a port of the wiring device, and can include exposed pads that simulate the signal connectors of a USB connector receptacle. The user can plug a device having a USB type C plug directly into the port to engage the tongue portion. The PCB itself can be built into the wiring device, and can include appropriate supporting circuitry to enable the resulting connector to communicate power, data or the like between the wiring device and a user's device, thereby providing an integrated connector that is transparent to the user. The PCB can also include features for providing a snap-fit connection between the plug and the connector.

As will be appreciated, the disclosed arrangement eliminates the need for using preformed connectors, which can reduce overall cost of the wiring device and can also provide flexibility in the design and/or layout of the connector within the device.

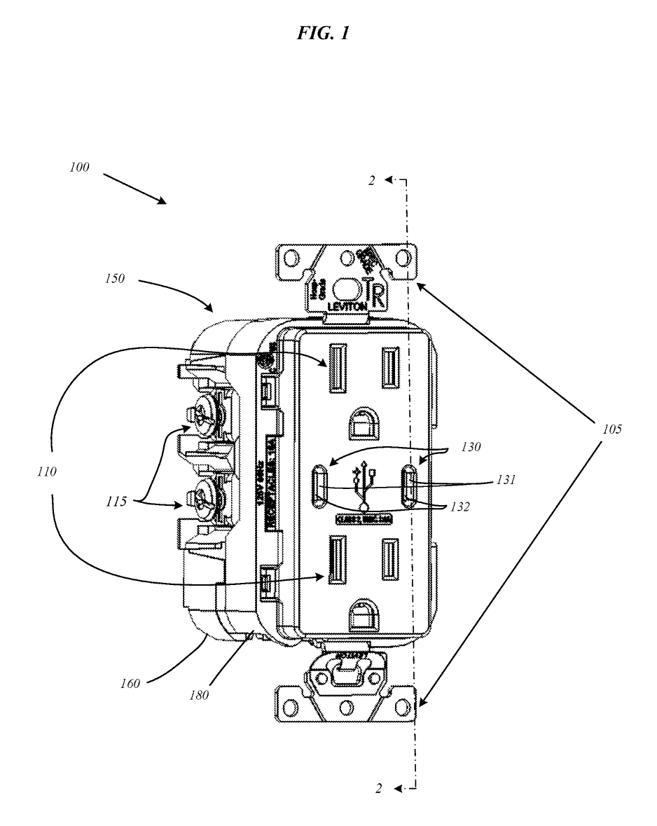

Referring now to FIG. 1, a wiring device 100 consistent with a non-limiting, exemplary embodiment of the present disclosure is shown. As will be appreciated, wiring devices are normally fastened to electrical boxes in walls and ceilings of buildings or in other suitable locations. Some examples of wiring devices include, but are not limited to switches, outlets, circuit interrupters, dimmers, occupancy sensors, and the like. Additionally, any suitable combinations of these devices can be integrated into a single wiring device.

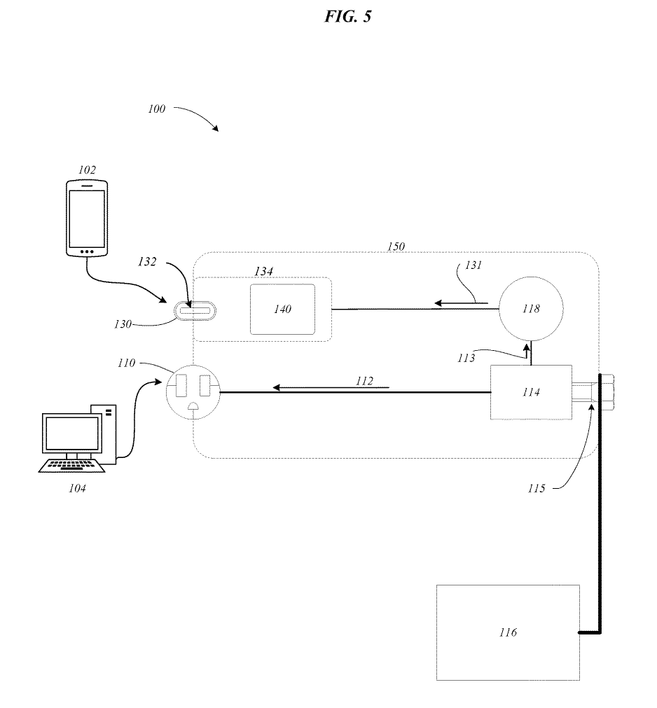

In the illustrated embodiment the wiring device 100 includes a strap 105, a front face 106, line-voltage ports 110, low-voltage ports 130 and a housing 150. The housing 150 may include rear and front cover portions 160, 180 that, when assembled, enclose a variety of components for delivering power from a line power source via terminals 115 to the line-voltage ports 110 and the low-voltage ports 130. Also visible are tongue portions 132 disposed within a plurality of side walls 131 of the low-voltage ports 130. As will be described in greater detail later, the side walls 131 of the low-voltage ports may be integrally formed with the front cover portion 160 and may serve as integral guide elements that guide the plug of a removable load 102, 104 (FIG. 5) into engagement with the tongue portions 132.

Line voltage refers to a voltage, typically Alternating Current (AC), that is supplied to buildings/residences (e.g., electric light and power), for example, 110 VAC, 115 VAC, 120 VAC, 125 VAC, 208 VAC, 220 VAC, 230 VAC, 240 VAC, single or multiphase. Line voltage is typically made available to the end user standard plug/outlet configurations standardized by the National Electrical Manufacturers' Association (NEMA) configurations.

Low voltage refers to a voltage which is less than a certain threshold (50 Volts for example, AC or DC). This reduced voltage is typically used for communication, signaling, data/multimedia transmission, low voltage charging, and the like. For the purposes of the present disclosure, the term low voltage also includes optical transmission (although no electrical voltage is actually transmitted by optical transmission).

Low voltage ports denote any suitable type of low voltage ports, such as, but not limited, to Universal Serial Bus (USB), Audio/Video/Multimedia ports, Digital Visual Interface (DVI), Ethernet/data ports, High Definition Multimedia Interface (HDMI), IEEE 1394 (FireWire), Separate Video (S-Video), Video Graphics Array (VGA), Telephone, and the like, or any suitable combination thereof. For the purposes of the present disclosure, low voltage ports can also include fiber optic ports (although no electrical voltage is actually transmitted by fiber optic ports). USB ports can further be broken out into various form factors such as Type A, Type B, Mini-A, Mini-B, Micro-A, Micro-B, or any other suitable form.

As mentioned, the housing 150 may include rear and front cover portions 160, 180 that, when assembled, enclose a variety of components for delivering power from a line power source 116 (FIG. 5) via the terminals 115 to the line-voltage ports 110 and the low-voltage ports 130. Where the wiring device 100 includes a ground fault current interrupter (GFCI), the housing 150 can also include the components associated with the GFCI, including one or more transformers, capacitors and the like. It will be appreciated that although the illustrated wiring device 100 is described as including both line-voltage and low-voltage ports 110, 130, such an arrangement is not critical and the disclosure contemplates wiring devices having only one or more low-voltage ports.

In some embodiments the low voltage ports 130 can be configured to provide a predetermined amount of charging current, or they may provide an amount of current based on the type of device that is plugged into the low voltage ports 130 (i.e., an on-demand current). Additionally, the low voltage ports 130 of the wiring device 100 can all provide the same level of charging current, or some or all of the low voltage ports 130 can provide different current levels from other ones of the low voltage ports. Low voltage ports 130 can communicate in any suitable manner with the device(s) plugged into low voltage ports (or any other device). Such communication can be in any suitable form such as unidirectional (one way), bidirectional (two way), wired, optically, and so on. In addition, such communication can utilize any suitable protocol or combinations of protocols, such as, but not limited to, Transmission Control Protocol/Internet Protocol (TCP/IP).

The low voltage ports 130 can optionally be configured to be controlled and/or connected in any suitable manner by the wiring device 100 or by remote devices. In the case of remote devices, these could be on a local network (e.g., LAN/Wi-Fi), and/or on a remote network (e.g., WAN/Internet).

The low voltage ports 130 can optionally be configured to simply transmit data or perform any other suitable function, or any suitable combination of functions. For example, the low voltage ports 130 may include an additional connector on the rear side of the wiring device 100 configured to receive a data cable from within the wall that the wiring device 100 is mounted in.

In operation, the wiring device 100 can receive current via terminals 115 from a line power source 116 (FIG. 5). In some embodiments the terminals 115 may include one or more clamps, screws, plates, and/or biasing members to ensure an electrical connection is made and maintained between the line power source 116 and the wiring device 100. Components within the housing 150 may condition the received electricity to deliver power in a safe and efficient manner to one or more of the removable loads 102, 104 by electrically coupling with a line-voltage or low-voltage port 110, 130 via at least one of the plurality of conductive terminals or traces in each port. In various embodiments, a circuit is completed between two of the plurality of conductive terminals or traces when the removable loads 102, 104 are electrically coupled to respective line-voltage or low-voltage port 110, 130.

As mentioned, the wiring device 100 may include a strap 105 configured to enable the wiring device 100 to be installed within an electrical junction box in a building to create an in-wall wiring device. In some embodiments, the wiring device 100 may be flush mounted in a wall of the building. The strap 105 may also enable a cover plate (not shown) to be attached to conceal the strap 105 and at least a portion of the housing 150 while enabling access to the line and low-voltage ports 110, 130 through associated apertures in the front face 106 of the wiring device 100.

As can be seen, the low-voltage ports 130 may be provided with tongue portions 132 are positioned to interact with a plug of a removable load 102. The tongue portions 132 can have a plurality of conductive traces for electrically coupling the wiring device with one or more removable loads 102 (see, e.g., FIG. 5) such as mobile devices (e.g., smart phones), any variety of portable consumer electronics (e.g., media players, drones, cameras), and the like. In a non-limiting exemplary embodiment the low-voltage port 130 is a universal serial bus (USB) receptacle and the removable loads 102 can include USB plugs.

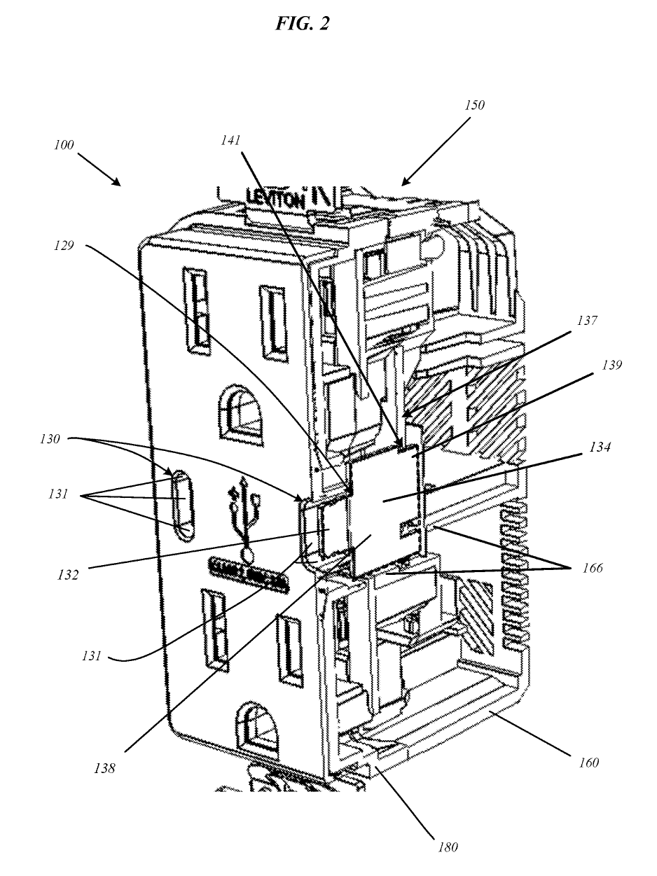

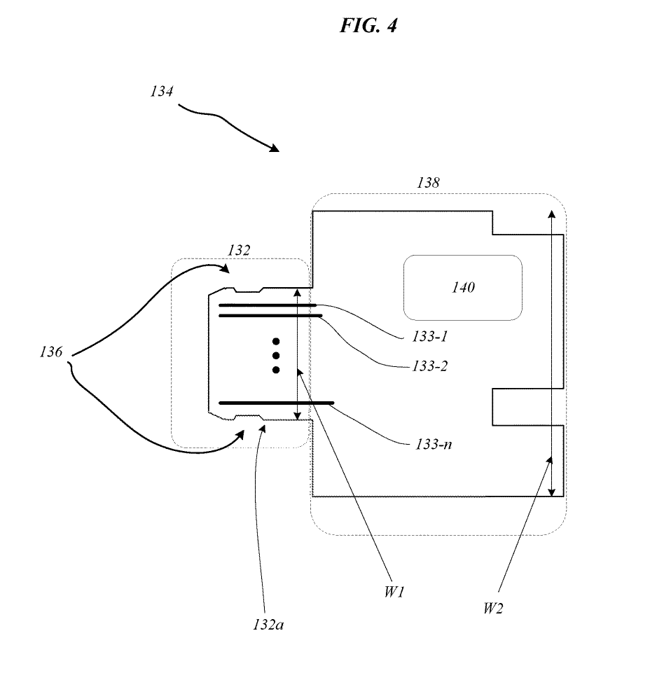

FIG. 2 shows a cutaway view of the wiring device 100, illustrating the placement of one of the tongue portions 132 within the housing 150. In the illustrated embodiment the tongue portion 132 is part of a connector PCB 134 that has a body portion 138 disposed within the housing 150. The connector PCB 134 can be positioned within the housing 150 so that a first end 132a (FIG. 4) of the tongue portion 132 extends through an opening 129 in the housing that corresponds to an associated low voltage port 130. Thus positioned, the tongue portion 132 is accessible in a way that enables it to conductively couple to a corresponding plug of a removable load 102.

As can be seen, the low voltage ports 130 comprise recesses in the front cover portion 180 which house respective tongue portions 132 of the connector PCBs 134. These recesses may be formed by a plurality of integrally formed side walls 131 that surround the tongue portion. The side walls 131 can be sized and configured to receive the plug of a removable load 102 and to guide the plug into engagement with the tongue portion 132 of the connector PCB 134 so that the contacts on the plug align and conductively engage with the conductive traces 133 (FIG. 4) of the tongue portion. The side walls 131 of the low voltage ports 130 thus act as guide channels, enabling the plug to slide along the side walls 131 of the low voltage ports 130 to appropriately engage the tongue portion 132 of the connector PCB 134. As a result, the typical metal guide/housing used with prior preformed receptacles is eliminated. As mentioned, the disclosed arrangement provides a simplified connection scheme by reducing the total number of components employed to form the low voltage connection.

In the illustrated embodiment the side walls 131 are sized and configured to receive and guide the plug portion of a USB-C connector, though this is merely exemplary and is not limiting. It will be appreciated that the side walls 131 of the low voltage ports 130 can be sized and configured to receive and guide the plug portions of any of the variety of other low-voltage connector types described in relation to FIG. 1.

In some embodiments, the front cover portion 180 can provide access to the connector tongue 132 while the connector body 138 can extend into the rear cover portion 160 of the housing 150. The rear cover portion 160 can include a plurality of structural mounting features 166 such as ledges, projections, slots and the like. In various embodiments, these internal structural mounting features 166 can be configured to hold the connector PCB 134 in a desired position within the housing 150 of wiring device 100.

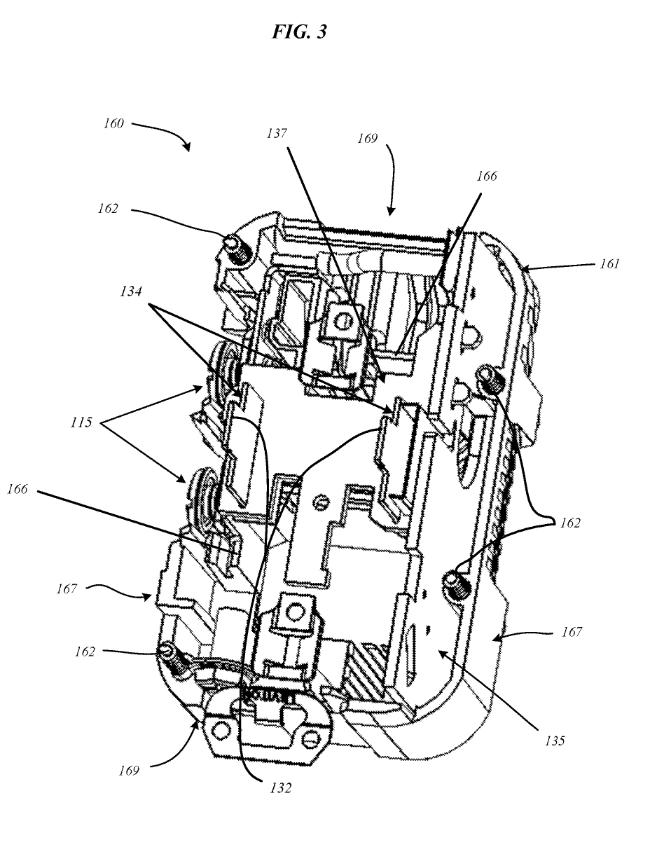

Referring now to FIG. 3, a non-limiting exemplary internal structure of the rear cover portion 160 of the wiring device 100 is shown. The rear cover portion 160 can include a back portion 161, side portions 167, top and bottom portions 169 and the plurality of internal structural mounting features 166. As will be appreciated, the internal structural mounting features 166 can be configured to hold internal components of the wiring device 100 in addition to the connector PCBs 134 in desired positions within the housing 150. These internal components may include electrical components, such as capacitors, transformers, conductors, and/or other PCBs. In some embodiments the structural mounting features 166 may also facilitate isolation of line voltage circuitry such as terminals 115 from the low-voltage circuitry within the wiring device 100. It will be appreciated that the front cover portion 180 may also include mounting features for mounting one or more components of the wiring device 100, such the low-voltage port 130.

In addition to the connector PCB 134, the wiring device 100 can include other PCBs which are configured to facilitate additional functionalities of the wiring device. In the illustrated embodiment the wiring device includes a first PCB 135 and a second PCB 137. The first PCB 135 can be a power PCB, meaning that it can have circuitry for conditioning power from a source of line power 116 and providing it to the line-voltage and low-voltage ports 110, 130. The second PCB 137 can be a power PCB or a logic PCB. In the illustrated embodiment the first PCB 135 can be oriented perpendicular to the second PCB 137 and parallel to the connector PCBs 134. The second PCB can be oriented parallel to the front face 106 of the wiring device 100, while the connector PCB 134 can be oriented perpendicular to the front face so that it is engageable with the plug of a removable load 102. It will be appreciated that the number, arrangement and functionality of the connector PCB 134, first PCB 135 and second PCB 137 are exemplary, and other combinations, arrangements and functionalities can be used without departing from the disclosure.

As will be appreciated, the connector PCB 134, first PCB 135 and second PCB 137 may comprise circuit boards other than PCBs, and are not limited to PCBs. The connector PCB 134, first PCB 135 and second PCB 137 can be electrically coupled to each other. In the embodiment shown in FIG. 2, the connector PCB 134 has a tab 139 formed on the body portion 138 at an end opposite the tongue portion 132. The tab 139 can be received in a corresponding recess 141 in the second PCB 137. Similarly, the second PCB 137 may include one or more tab portions 137a received within corresponding recesses 135a in the first PCB 135. The connector PCB 134, first PCB 135 and second PCB 137 may each include plating for making electrical connections therebetween.

The electronic components of the wiring device 100 can be coupled to at least one of the first and second PCBs 135, 137 and/or the connector PCB 134. In some embodiments the connector PCB 134 may be a logic PCB while the first PCB 135 may be a power PCB. The second PCB 137 may be a logic PCB and/or a power PCB. It will be appreciated, however, that the configuration of the functionality of the connector PCB 134, the first PCB 135 and the second PCB 137, as well as the interconnection thereof and the electrical components coupled thereto is merely exemplary and that other configurations are within the scope of the present disclosure.

The first PCB 135 and second PCB 137 can be joined together at a right angle therebetween, without intervening material. Likewise, the connector PCB 134 and the second PCB 137 can be joined together at a right angle therebetween, without intervening material. The PCBs can be joined by any appropriate technique including, but not limited to, soldering. Such an arrangement makes for efficient use of the volume within the housing 150, simplifies manufacture and reduces cost. Alternatively, the PCBs can be electrically connected together through any suitable medium such as but not limited to PCB connector(s), wires, bus bars, or any combination thereof. Wiring device 100 can include circuitry used to transform line voltage to low voltage, as will be described in greater detail later. As mentioned, this circuitry may reside on the first and/or second PCB 135, 137. Alternatively, the line to low voltage transformation circuitry may reside at any other suitable location.

In the illustrated embodiment the wiring device 100 further includes a plurality of fasteners 162 (e.g., screws, pins, clips) for coupling the rear cover portion 160 to the front cover portion 180 in a conventional manner. The fasteners 162 may be disposed proximate one or more of the top or bottom portions 169 and the side portions 167 to help insure the front cover portion 180 seats against the rear cover portion 180 when the housing 150 is assembled (see, e.g., FIG. 2).

Referring now to FIG. 4, the connector PCB 134 can include a tongue portion 132 and a body 138 portion which can both be part of a single PCB. The tongue 132 may include retention surface features 136 while the body portion 138 may include support circuitry 140. Non-limiting exemplary embodiments of appropriate support circuitry 140 include a USB interface circuit, an LED interface circuit, a humidity sensor interface circuit, and the like, depending on how much room is available on the body portion 138. In some embodiments, the first PCB 135, second PCB 137 and/or the connector PCB 134 may also or alternatively incorporate a processor or chip to enable the wiring device 100 to communicate and recognize what type of removable load 102 the wiring device is communicating with (e.g., a specific cellphone, a tablet, a camera or the like.) Using such a communication concept, the removable load 102 can be charged at a maximum allowable charge for the removable load as long as the wiring device 100 is capable of delivering such load. Such a concept may also allow the wiring device 100 to manage power distribution to each low-voltage port 130 based on charging levels and the removable load(s) 102 plugged into the port.

As mentioned, in some embodiments the first PCB 135, second PCB 137 and/or the connector PCB 134 can include power supply circuitry as well as circuitry that provides different functionalities, such as a USB interface for the USB port or module, a light emitting diode (LED) circuit for an LED light or module, a humidity sensor interface for a humidity sensor or module, and the like. In one embodiment the power supply circuitry can be provided on the first PCB 135, while the USB interface, LED circuit, humidity sensor interface or the like may be provided on the connector PCB 134.

Conductive traces 133-1-n may be disposed on the tongue portion 132 in a manner that mimics the signal connectors of a USB connector receptacle. The conductive traces 133-1-n may cross between the tongue portion 132 and the body portion 138 of the connector PCB 134.

As can be seen, the tongue portion 132 may have a width “W1” that is smaller than a width “W2” of the body portion 138. This arrangement enables the tongue portion 132 to fit within the opening 129 in the housing 150 that corresponds to an associated low voltage port 130, while also providing a desired larger area on the body portion 138 for disposal of support circuitry 140 as previously described.

The retention surface features 136 can be recesses, notches, shoulders or the like that engage and retain a plug of a removable load 102. In operation, the tongue portion 132 of the connector PCB 134 can couple with a removable load 102 (FIG. 5) to complete a circuit. The retention surface features 136 contact the removable load 102 to retain the tongue 132 engaged with the removable load 102. When coupled with a removable load 102, one or more of the conductive traces 133 may physically and electrically connect with corresponding contacts of the removable load 102 to complete a circuit and to provide power and/or data services to the removable load 102.

In different embodiments, the number of conductive traces 133-1-n on the connector PCB 134 may change. For example, if the connector PCB 134 is configured to provide power and data services to removable loads 102, then 16 or more different conductive traces 133 may be used. Alternatively, if the connector PCB 134 is configured to only provide power to removable loads 102, then fewer conductive traces 133 may be used. In some embodiments conductive traces 133 may be exposed on both faces of the connector PCB 134.

Referring now to FIG. 5, an exemplary block diagram of the wiring device 100 is shown. The wiring device 100 may include a first removable load 102, a second removable load 104, and a line power source 116. The wiring device 100 may further include housing 150, line-voltage port 110, and low-voltage port 130.

The housing 150 may enclose a line-voltage distributor 114, a rectifier 118, and at least a portion of connector PCB 134. The connector PCB 134 may include support circuitry 140 such as logic circuitry or power circuitry. The connector PCB 134 may conductively couple one or more components of the connector PCB 134 to provide electrical connections there between.

In operation, the wiring device 100 may receive an alternating current from the line power supply 116 via the line-voltage distributor 114. The line power source 116 may be electrically coupled with the line-voltage distributor 114 via terminals 115. All or part of the terminals 115 may conduct power from the line power source 116 to the line-voltage distributor 114. In some embodiments the terminals 115 may include one or more clamps, screws, plates, and biasing members.

The line-voltage distributor 114 may provide a first alternating current 112 to one or more second removable loads 104 when the removable loads 104 are electrically coupled to the wiring device 100 via conductive terminals of the line-voltage ports 110. The electric potential between at least two of the conductive terminals may be approximately the voltage of the alternating current supply 116. The line-voltage distributor 114 may provide a second alternating current 113 to the rectifier 118. In some embodiments the first and second alternating currents 112, 113 are the same alternating current.

The rectifier 118 may convert the second alternating current 113 into direct current (DC) to provide to the low-voltage ports 130. The low-voltage ports 130 may provide the direct current 131 to one or more first removable loads 102 when the removable loads 102 are electrically coupled to the wiring device 100 via conductive traces 133-1-n (FIG. 4) of the connector PCB 134. The electric potential between at least two of the conductive traces 133-1-n of each connector PCB 134 may be approximately the voltage of the first direct current 131. Various embodiments may individually control the current delivered to each of the first removable loads 102. In various such embodiments, the logic circuitry 140 of each connector PCB may control the current delivered to the respective first removable load 102.

It will be appreciated that although components described herein may be illustrated as separate or combined, they may readily be rearranged without departing from the scope of the present disclosure. For example, the rectifier 118 and line-voltage distributor 114 may be included on a second PCB. In another example, the line-voltage distributor may be included on a second PCB while the rectifier 118 is provided on a third PCB.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

Some embodiments of the disclosed device may be implemented, for example, using a storage medium, a computer-readable medium or an article of manufacture which may store an instruction or a set of instructions that, if executed by a machine (i.e., processor or microcontroller), may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable line-level, low-level, object-oriented, visual, compiled and/or interpreted programming language.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

What is claimed is:

1. A wiring device, comprising:
a housing having a low-voltage port; and
a connector printed circuit board (PCB) disposed within the housing, the connector PCB having a tongue portion, a body portion and a conductive trace, the conductive trace disposed on the tongue portion and the body portion, a first end of the tongue portion disposed within the low-voltage port;
wherein the low-voltage port comprises a plurality of sidewalls comprising guide surfaces configured to receive the plug of a removable load to guide the plug into engagement with the tongue portion so that the contacts on the plug align and conductively engage with the conductive traces of the tongue portion.

2. The wiring device of claim 1, the plurality of sidewalls and the tongue portion comprise a universal serial bus (USB) receptacle.

3. The wiring device of claim 1, wherein the connector PCB is coupled to a second PCB disposed in the housing.

4. The wiring device of claim 3, the second PCB oriented parallel to a front face of the wiring device, and the connector PCB oriented perpendicular to the front face.

5. The wiring device of claim 3, wherein the connector PCB and the second PCB are electrically coupled to each other.

6. The wiring device of claim 3, wherein the connector PCB comprises a tab formed on the body portion at an end opposite the tongue portion, the tab received in a corresponding recess in the second PCB.

7. The wiring device of claim 3, the second PCB comprising at least one of a power PCB and a logic PCB.

8. The wiring device of claim 1, the body portion of the connector PCB coupled to a structure mounting feature disposed within the housing.

9. The wiring device of claim 1, wherein the body portion comprises a power PCB or a logic PCB.

10. The wiring device of claim 1, wherein the tongue portion has a width that is smaller than a width of the body portion, the width of the tongue portion sized to engage a corresponding surface of a USB plug.

11. A wiring device comprising:
a housing including a low voltage port;
a connector printed circuit board (PCB) including a body portion and a tongue portion;
a first conductive trace with first and second ends, the first end located on the body portion and the second end located on the tongue portion; and
a second conductive trace with first and second ends, the first end located on the body portion and the second end located on the tongue portion;
wherein the tongue portion has a first end disposed within the low voltage port; and
wherein the low-voltage port includes a sidewall disposed adjacent the tongue portion, the sidewall configured to receive a surface of the plug of a removable load to guide the plug into engagement with the tongue portion so that first and second electrical contacts on the plug align and conductively engage with the conductive traces of the tongue portion.

12. The wiring device of claim 11, the low voltage port and tongue portion comprise a universal serial bus (USB) receptacle.

13. The wiring device of claim 11, wherein the connector PCB is coupled to a second PCB disposed within the housing.

14. The wiring device of claim 13, the second PCB oriented parallel to a front face of the wiring device, and the connector PCB oriented perpendicular to the front face.

15. The wiring device of claim 13, wherein the connector PCB and the second PCB are electrically coupled to each other.

16. The wiring device of claim 13, wherein the connector PCB comprises a tab formed on the body portion at an end opposite the tongue portion, the tab received in a corresponding recess in the second PCB.

17. The wiring device of claim 13, the second PCB comprising at least one of a power PCB and a logic PCB.

18. The wiring device of claim 11, the body portion of the connector PCB coupled to a structure mounting feature disposed within the housing.

19. A wiring device comprising:
a housing including a low voltage port;
a connector printed circuit board (PCB) including a body portion and a tongue portion, the tongue portion having a first end disposed within the low voltage port; and
a plurality of conductive traces each having first and second ends, the first ends disposed on the body portion and the second ends disposed on the tongue portion;
wherein a front portion of the housing has a plurality of sidewalls disposed around the tongue portion, the plurality of sidewalls comprising a guide channel for receiving and guiding a plug of a removable load into engagement with the tongue portion so that a contact on the plug conductively engages with at least one of the conductive traces of the tongue portion.

20. The wiring device of claim 19, wherein the plurality of sidewalls of the low voltage port and the tongue portion form a USB-C receptacle.
